(19) United States
(12) Patent Application Publication
(10) Pub. No.: US 2021/0049547 A1
(43) Pub. Date: Feb. 18, 2021

(54) Method for Gas Station-Based Parcel Delivery Service and System for Implementing Same

(71) Applicant: SK Energy Co., Ltd., Seoul (KR)

(72) Inventors: Myong Suk Yoon, Seoul (KR); Joon Sik Ko, Seoul (KR)

(21) Appl. No.: 16/964,417

(22) PCT Filed: Jan. 22, 2019
(86) PCT No.: PCT/KR2019/000891

§ 371 Date: Jul. 23, 2020

(30) Foreign Application Priority Data
Jan. 24, 2018 (KR) 10-2018-0008680

(51) Int. Cl. G06Q 10/08; G06Q 10/06; G06Q 30/00; G06K 9/32; G06K 9/46

(52) U.S. Cl. CPC G06Q 10/0838; G06Q 10/06315; G06K 2007/10504; G06K 9/325; G06K 9/46; G06Q 30/0185

(57) ABSTRACT

The present invention provides a method for a gas station-based parcel delivery service and a system for implementing the same. The disclosed system according to one embodiment includes a server computing device including one or more processors, a memory, and one or more programs, wherein the one or more programs are stored in the memory and configured to be executed by the one or more processors, wherein the one or more programs comprising instructions that, when executed, cause the server computing device to: receive a parcel delivery request including parcel delivery-related information from a client terminal; select a parcel delivery reception terminal and a logistics hub gas station based on the parcel delivery-related information; transmit a parcel delivery reception selection notification including the parcel delivery-related information and logistics hub gas station information to a quick service terminal selected as the parcel delivery reception terminal; transmit a logistics hub gas station selection notification including the parcel delivery-related information and information on the quick service terminal to a gas station hub terminal of a gas station selected as the logistics hub gas station; and transmit the parcel delivery-related information and the logistics hub gas station information to a parcel delivery company management server that covers the logistics hub gas station.

### TECHNICAL FIELD

Embodiments of the present invention relate to a technique for a parcel delivery service.

### BACKGROUND ART

In general, gas stations are evenly located in each downtown area. The gas station has an unused space that allows entry and exit of large lorries and allows loading and unloading of goods. Therefore, there is a need for a method to utilize such a gas station as a logistics hub.

### PRIOR ART DOCUMENT

[Patent Document]

(Patent Document 01) Korean Patent Laid-Open Publication No. 10-2014-0023013 (Feb. 26, 2014)

(Patent Document 02) Korean Patent Registration Publication No. 10-1193596 (Oct. 24, 2012)

### SUMMARY OF INVENTION

### Problems to be Solved by Invention

Embodiments of the present invention are directed to provide a method for a gas station-based parcel delivery service capable of utilizing the gas station as a logistics hub and a system for executing the method.

### Means for Solving Problems

One aspect of the present invention provides a system for providing a gas station-based parcel delivery service, the system including: a server computing device including one or more processors, a memory, and one or more programs, wherein the one or more programs are stored in the memory and configured to be executed by the one or more processors, wherein the one or more programs including instructions that, when executed, cause the server computing device to: receive a parcel delivery request including parcel delivery-related information from a client terminal; select a parcel delivery reception terminal and a logistics hub gas station based on the parcel delivery-related information; transmit a parcel delivery reception selection notification including the parcel delivery-related information and logistics hub gas station information to a quick service terminal selected as the parcel delivery reception terminal; transmit a logistics hub gas station selection notification including the parcel delivery-related information and information on the quick service terminal to a gas station hub terminal of a gas station selected as the logistics hub gas station; and transmit the parcel delivery-related information and the logistics hub gas station information to a parcel delivery company management server that covers the logistics hub gas station.

The parcel delivery-related information may include parcel delivery sender information, parcel delivery product information, and parcel delivery recipient information, and the instruction to select the parcel delivery reception terminal may cause the server computing device to select the parcel delivery reception terminal among a plurality of quick service terminals communicatively connected to the server computing device based on a sender's address of the parcel delivery sender information and each location information of the quick service terminals.

The parcel delivery-related information may include parcel delivery sender information, parcel delivery product information, and parcel delivery recipient information, and the instruction to select the logistics hub gas station may cause the server computing device to select the logistics hub gas station based on one or more of the sender's address of the parcel delivery sender information and the location information of the pre-registered gas stations among the pre-registered gas stations.

The parcel delivery-related information may include parcel delivery sender information, parcel delivery product information, and parcel delivery recipient information, and the one or more programs may further include instructions that, when executed, cause the server computing device to: receive, from the quick service terminal, a message notifying that a collection of a parcel delivery product has been completed at the sender's address of the parcel delivery sender information; and receive, from the quick service terminal, a message notifying that the delivery of the parcel delivery product to the logistics hub gas station as a logistics hub has been completed.

The system may further include the gas station hub terminal, wherein the gas station hub terminal includes a reader which reads a tag sticker attached to each parcel delivery product, and the gas station hub terminal may be configured to perform operations of: extracting the parcel delivery-related information from the tag sticker; and determining whether there is a parcel delivery error according to whether the extracted parcel delivery-related information and the parcel delivery-related information received from the server computing device coincide with each other.

The system may further include the quick service terminal, wherein the quick service terminal may be configured to perform operations of: generating an alarm when receiving the parcel delivery reception selection notification from the server computing device; and displaying a sender's address and an address of the logistics hub gas station included in the parcel delivery reception selection notification on a screen thereof.

Another aspect of the present invention provides a system for providing a gas station-based parcel delivery service, the system including: a server computing device including one or more processors, a memory, and one or more programs, wherein the one or more programs are stored in the memory and configured to be executed by the one or more processors, wherein the one or more programs including instructions that, when executed, cause the server computing device to: receive a parcel delivery request including parcel delivery-related information from a client terminal; confirm whether a license number of a user is included in the parcel delivery request; generate a logistics hub gas station list based on parcel delivery sender information included in the parcel delivery-related information and transmit the logistics hub gas station list to the client terminal when the license number of the user is included in the parcel delivery request; and transmit a parcel delivery entrustment application including the license number of the user and the parcel delivery-related information to gas station hub terminals of gas stations included in the logistics hub gas station list.

In the instruction to generate the logistics hub gas station list, the one or more programs may extract gas stations located within a preset distance based on a sender's address of the parcel delivery sender information among the pre-registered gas stations to generate the logistics hub gas station list.

The system may further include the gas station hub terminal, wherein the gas station hub terminal may be configured to perform operations of: recognizing a license number of a vehicle entering a gas station where the gas station hub terminal is installed; confirming whether there is a parcel delivery entrustment application corresponding to the recognized license number; and when there is the parcel delivery entrustment application corresponding to the recognized license number, generating a parcel delivery collection signal.

The gas station hub terminal may be configured to further perform an operation of: after the operation of generating the parcel delivery collection signal, transmitting, to the server computing device, a message notifying that a collection of a parcel delivery product for the parcel delivery entrustment application has been completed.

The system may further include the gas station hub terminal, wherein the gas station hub terminal may be configured to perform operations of: recognizing a license number of a vehicle entering the gas station where the gas station hub terminal is installed; confirming whether there is parcel delivery recipient information corresponding to the recognized license number among pre-stored parcel delivery-related information; and when there is the parcel delivery recipient information corresponding to the recognized license number, generating a parcel delivery signal.

In addition, another aspect of the present invention provides a system for providing a gas station-based parcel delivery service, including: a parcel delivery company management server configured to select a logistics hub gas station for a parcel delivery product based on parcel delivery recipient information among parcel delivery-related information included in a parcel delivery request, and transmit a logistics hub gas station selection notification including the parcel delivery-related information; a gas station hub terminal configured to receive the logistics hub gas station selection notification, obtain the parcel delivery-related information from a tag sticker attached to the parcel delivery product, compare the obtained parcel delivery-related information with the parcel delivery-related information included in the logistics hub gas station selection notification to determine whether there is a parcel delivery error, and transmit a quick service request including the parcel delivery-related information; and a gas station parcel delivery management server configured to receive the quick service request, select a parcel delivery reception terminal among a plurality of quick service terminals based on a location of the logistics hub gas station and each location of the quick service terminals, and transmit a parcel delivery reception selection notification including the parcel delivery-related information and logistics hub gas station information to the quick service terminal selected as the parcel delivery reception terminal.

Further, another aspect of the present invention provides a method for a gas station-based parcel delivery service performed in a computing device including one or more processors, and a memory which stores one or more programs executed by the one or more processors, the method including: receiving a parcel delivery request including parcel delivery-related information from a client terminal; selecting a parcel delivery reception terminal and a logistics hub gas station based on the parcel delivery-related information; transmitting a parcel delivery reception selection notification including the parcel delivery-related information and logistics hub gas station information to a quick service terminal selected as the parcel delivery reception terminal; transmitting a logistics hub gas station selection notification including the parcel delivery-related information and information on the quick service terminal to a gas station hub terminal of a gas station selected as the logistics hub gas station; and transmitting the parcel delivery-related information and the logistics hub gas station information to a parcel delivery company management server that covers the logistics hub gas station.

The parcel delivery-related information may include parcel delivery sender information, parcel delivery product information, and parcel delivery recipient information, and the step of selecting the parcel delivery reception terminal may select the parcel delivery reception terminal among a plurality of quick service terminals based on a sender's address of the parcel delivery sender information and each location information of the quick service terminals.

The parcel delivery-related information may include parcel delivery sender information, parcel delivery product information, and parcel delivery recipient information, and the step of selecting the logistics hub gas station may select the logistics hub gas station based on one or more of the sender's address of the parcel delivery sender information and the location information of the pre-registered gas stations among the pre-registered gas stations.

The parcel delivery-related information may include parcel delivery sender information, parcel delivery product information, and parcel delivery recipient information, and the method may further include: receiving, from the quick service terminal, a message notifying that a collection of a parcel delivery product has been completed at the sender's address of the parcel delivery sender information; and receiving, from the quick service terminal, a message notifying that the delivery of the parcel delivery product to the logistics hub gas station as a logistics hub has been completed.

Further, another aspect of the present invention provides a method for a gas station-based parcel delivery service performed in a computing device including one or more processors, and a memory which stores one or more programs executed by the one or more processors, the method including: receiving a parcel delivery request including parcel delivery-related information from a client terminal; confirming whether a license number of a user is included in the parcel delivery request; generating a logistics hub gas station list based on parcel delivery sender information included in the parcel delivery-related information and transmitting the logistics hub gas station list to the client terminal when the license number of the user is included in the parcel delivery request; and transmitting a parcel delivery entrustment application including the license number of the user and the parcel delivery-related information to gas station hub terminals of gas stations included in the logistics hub gas station list.

The step of generating the logistics hub gas station list may extract gas stations located within a preset distance based on a sender's address of the parcel delivery sender information among the pre-registered gas stations to generate the logistics hub gas station list.

Furthermore, another aspect of the present invention provides a method for a gas station-based parcel delivery service performed in a computing device including one or more processors, and a memory which stores one or more programs executed by the one or more processors, the method including: receiving a parcel delivery entrustment application including a license number of a user and parcel delivery-related information from a gas station parcel delivery management server; recognizing a license number of a vehicle entering a gas station where the computing device is installed; confirming whether there is a parcel delivery entrustment application corresponding to the recognized license number; and when there is the parcel delivery entrustment application corresponding to the recognized license number, generating a parcel delivery collection signal.

The method may further include, after the step of generating the parcel delivery collection signal, transmitting, to the server computing device, a message notifying that a collection of a parcel delivery product for the parcel delivery entrustment application has been completed.

### Advantageous Effects

According to the disclosed embodiments, by utilizing an unused space of the gas station located in various downtown areas, which allows entry and exit of large lorries and allows loading and unloading of goods, as a logistics hub, it is possible for the customers to conveniently apply for parcel delivery using an application, and it is possible for the parcel delivery companies to increase a logistics collection efficiency in the downtown area while reducing costs, as well as it is possible for the gas stations to create additional profits by utilizing the unused space as a logistics hub for parcel delivery.

### BRIEF DESCRIPTION OF DRAWINGS

FIG. 1 is a block diagram illustrating a configuration of a system for a gas station-based parcel delivery service according to one embodiment of the present invention.

FIG. 2 is a flowchart illustrating a method for a gas station-based parcel delivery service according to one embodiment of the present invention.

FIG. 3 is a flowchart illustrating a method for a gas station-based parcel delivery service according to another embodiment of the present invention.

FIG. 4 is a flowchart illustrating a method for a gas station-based parcel delivery service according to another embodiment of the present invention.

FIG. 5 is a block diagram illustrating and describing a computing environment which includes a computing device suitable to be used in the exemplary embodiments.

### MODE FOR CARRYING OUT INVENTION

Hereinafter, specific embodiments of the present invention will be described with reference to the accompanying drawings. The following detailed description is provided to contribute to a comprehensive understanding of a method, apparatus, and/or system described herein. However, these embodiments merely illustrative examples, and the present invention is not limited thereto.

In descriptions of the embodiments of the present invention, publicly known techniques that are judged to be able to make the purport of the present invention unnecessarily obscure will not be described in detail. Referring to the drawings, wherein like reference characters designate like or corresponding parts throughout the several views. In addition, the terms as used herein are defined by taking functions of the present disclosure into account and can be changed according to the custom or intention of users or operators. Therefore, definition of the terms should be made according to the overall disclosure set forth herein. In addition, the terminology used herein is for the purpose of describing particular embodiments only and is not intended to limit the present invention thereto. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In the following description, terms such as “transfer,” “communication,” “transmission,” and “reception” of a signal or information and other similar terms refer to a signal or information which is directly transmitted from one component to another component and a signal or information which is transmitted from one component to another element via yet another component. Specifically, the transfer or transmission of a signal or information to one component indicates a final destination of the signal or information and does not indicate a direct destination of the signal or information. This is the same in the “reception” of the signal or information. Further, in this specification, the fact that two or more pieces of data or information are “related” means that when one piece of data (or information) is obtained, at least a part of other data (or information) may be obtained on the basis of the obtained data (or information).

Further, it will be understood that, although the terms first, second, etc. may be used herein to describe various elements, components or sections, these elements, components or sections should not be limited by these terms. These terms are only used to distinguish one element, component or section from another element, component or section. Thus, a first element, component or section discussed below could be termed a second element, component or section without departing from the teachings of the present invention.

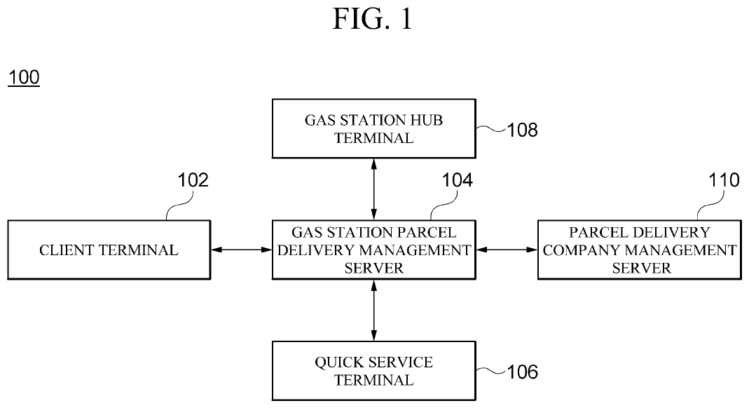

FIG. 1 is a block diagram illustrating the configuration of a system for a gas station-based parcel delivery service according to one embodiment of the present invention.

Referring to FIG. 1, a system 100 for a gas station-based parcel delivery service may include a client terminal 102, a gas station parcel delivery management server 104, a quick service terminal 106, a gas station hub terminal 108, and a parcel delivery company management server 110. In this case, the client terminal 102, the quick service terminal 106, the gas station hub terminal 108, and the parcel delivery company management server 110 may be communicatively connected to the gas station parcel delivery management server 104 through a communication network (not illustrated), respectively.

In some embodiments, the communication network may include the Internet, one or more local area networks, wire area networks, cellular networks, mobile networks, other types of networks, or a combination of these networks.

The client terminal 102 may be a terminal of a parcel delivery sender. The client terminal 102 may transmit a parcel delivery request including parcel delivery-related information to the gas station parcel delivery management server 104. Herein, the parcel delivery-related information may include parcel delivery sender information (name, address, etc. of a sender), parcel delivery product information (type, size, weight, etc. of a product), and parcel delivery recipient information (name, address, etc. of a recipient).

The client terminal 102 may receive parcel delivery-related information input from a user. The client terminal 102 may calculate a parcel delivery cost based on the received parcel delivery-related information. The client terminal 102 may perform a payment for the calculated parcel delivery cost.

An application for providing a gas station-based parcel delivery service may be installed in the client terminal 102. The application may be stored in a computer-readable storage medium of the client terminal 102. The application includes a predetermined set of instructions executable by a processor of the client terminal 102. The instructions cause the processor of the client terminal 102 to perform an operation according to the exemplary embodiments. The computer-readable storage medium of the client terminal 102 includes components of an operating system for executing the set of instructions such as the application on the client terminal 102. For example, such an operating system may be Apple's iOS or Google's Android.

The gas station parcel delivery management server 104 may be a server computing device for managing the system 100 for a gas station-based parcel delivery service. When receiving a parcel delivery request from the client terminal 102, the gas station parcel delivery management server 104 may select any one quick service terminal 106 as a parcel delivery reception terminal based on the parcel delivery-related information included in the parcel delivery request. When the parcel delivery request is received from the client terminal 102, the gas station parcel delivery management server 104 may assign a unique identification number to the parcel delivery request. The unique identification number of the parcel delivery request may be included in the parcel delivery-related information by the gas station parcel delivery management server 104.

In exemplary embodiments, the gas station parcel delivery management server 104 may select any one quick service terminal 106 as the parcel delivery reception terminal based on the address information of the sender among the parcel delivery-related information and location information among a plurality of quick service terminals 106. The gas station parcel delivery management server 104 may select a quick service terminal 106 located closest to the sender's address among the plurality of quick service terminals 106 as the parcel delivery reception terminal.

Alternatively, the gas station parcel delivery management server 104 respectively transmits the parcel delivery request to the plurality of quick service terminals 106 located within a preset distance based on the sender's address, and then selects a quick service terminal 106 that responds fastest to the parcel delivery request as the parcel delivery reception terminal.

In addition, the gas station parcel delivery management server 104 may select a gas station to be used as the logistics hub for the parcel delivery product based on the parcel delivery-related information. That is, the gas station parcel delivery management server 104 may select a gas station to be used as the logistics hub for the parcel delivery product among the pre-registered gas stations. In this case, a gas station having a condition suitable for use as the logistics hub (for example, a condition in which the gas station is convenient for transportation and has a large unused space) among the gas stations may be registered in the gas station parcel delivery management server 104 in advance.

In exemplary embodiments, the gas station parcel delivery management server 104 may select a gas station located closest to the sender's address as a gas station to be used for the logistics hub for the parcel delivery product among the pre-registered gas stations. Alternatively, the gas station parcel delivery management server 104 may select a gas station predicted to take the shortest delivery time by the quick service as a logistics hub gas station for the parcel delivery product based on traffic status information between the sender's address and the pre-registered gas stations and distances between the sender's address and the pre-registered gas stations.

The gas station parcel delivery management server 104 may transmit a parcel delivery reception selection notification including the parcel delivery-related information and logistics hub gas station information to the quick service terminal 106 selected as the parcel delivery reception terminal. The logistics hub gas station information may include name information and address information of the gas station.

In addition, the gas station parcel delivery management server 104 may transmit information on the parcel delivery reception selection terminal and the logistics hub gas station information to the client terminal 102. When the parcel delivery reception terminal is selected, the gas station parcel delivery management server 104 may set a state for the parcel delivery product as a reception complete. In addition, the gas station parcel delivery management server 104 may transmit a logistics hub gas station selection notification including the parcel delivery-related information and the information on the parcel delivery reception selection terminal to the gas station hub terminal 108 installed at the gas station selected as the logistics hub gas station.

Further, the gas station parcel delivery management server 104 may transmit the parcel delivery-related information and the logistics hub gas station information to the parcel delivery company management server 110. When a logistics hub gas station is selected, the gas station parcel delivery management server 104 may transmit the parcel delivery-related information and the logistics hub gas station information to the parcel delivery company management server 110 that covers the logistics hub gas station.

The gas station parcel delivery management server 104 may monitor a progress of the parcel delivery related to the parcel delivery request. The gas station parcel delivery management server 104 may transmit the progress of the parcel delivery to the client terminal 102.

The quick service terminal 106 may be a terminal of a person who provides a quick service. In exemplary embodiments, the quick service may be a service for delivering a parcel delivery product from the parcel delivery sender to the logistics hub gas station. The quick service terminal 106 may transmit its location information periodically or in real time to the gas station parcel delivery management server 104.

When receiving the parcel delivery reception selection notification from the gas station parcel delivery management server 104, the quick service terminal 106 may generate an alarm notifying that it has been selected as the parcel delivery reception terminal. The quick service terminal 106 may display the sender's address and an address of the logistics hub gas station included in the parcel delivery reception selection notification on a screen thereof. When receiving the parcel delivery reception selection notification, a user of the quick service terminal 106 may visit the sender's address to collect the parcel delivery product. The user of the quick service terminal 106 may attach a tag sticker on which the parcel delivery-related information and information on the logistics hub gas station are recorded to the parcel delivery product.

The quick service terminal 106 may transmit, to the gas station parcel delivery management server 104, a message notifying that a collection of the parcel delivery product has been completed according to an input of the user. Accordingly, the gas station parcel delivery management server 104 may set the status of the parcel delivery product as collection completion.

The user of the quick service terminal 106 may deliver the collected parcel delivery product to the logistics hub gas station. The quick service terminal 106 may transmit, to the gas station parcel delivery management server 104, a message notifying that a delivery of the parcel delivery product to the logistics hub has been completed according to the input of the user. Accordingly, the gas station parcel delivery management server 104 may set the status of the parcel delivery product as delivery completion to the logistics hub.

An application for providing a gas station-based parcel delivery service may be installed in the quick service terminal 106. The application may be stored in a computer-readable storage medium of the quick service terminal 106. The application includes a predetermined set of instructions executable by a processor of the quick service terminal 106. The instructions cause the processor of the quick service terminal 106 to perform an operation according to the exemplary embodiments. The computer-readable storage medium of the quick service terminal 106 includes components of an operating system for executing the set of instructions such as the application on the quick service terminal 106. For example, such an operating system may be Apple's iOS or Google's Android.

The gas station hub terminal 108 may be installed at each gas station used as a logistics hub for the parcel delivery product. The gas station hub terminal 108 may include a reader that can read tag stickers attached to each parcel delivery product. The gas station hub terminal 108 may extract the parcel delivery-related information and the logistics hub gas station information from the tag sticker. The gas station hub terminal 108 may confirm whether the parcel delivery-related information extracted from the tag sticker and the parcel delivery-related information received from the gas station parcel delivery management server 104 coincide with each other.

That is, the gas station hub terminal 108 may confirm whether the sender's address, the parcel delivery product information, and a recipient's address of the parcel delivery-related information extracted from the tag sticker and the sender's address, the parcel delivery product information, and the recipient's address of the parcel delivery-related information received from the gas station parcel delivery management server 104 coincide with each other. If at least one of them is inconsistent, the gas station hub terminal 108 may transmit to the gas station parcel delivery management server 104 that there is an error in the parcel delivery status.

In addition, the gas station hub terminal 108 may confirm whether the logistics hub gas station information extracted from the tag sticker and information about the gas station on which the gas station hub terminal 108 is installed, and if the information is inconsistent, may transmit to the gas station parcel delivery management server 104 that there is an error in the parcel delivery status.

The parcel delivery company management server 110 may be a server computing device of a company that specializes in the parcel delivery service. The parcel delivery company may cover a plurality of logistics hub gas stations according to contracts between the company and owners of the gas stations or franchise members of the gas stations (for example, SK gas station, S-Oil, GS gas station, Hyundai Oil Bank, etc.).

The parcel delivery company management server 110 may manage the delivery of the parcel delivery product from the logistics hub gas station to the recipient's address. The parcel delivery company management server 110 may transmit the delivery status, in which each parcel delivery product has been delivered to the recipient's address from the logistics hub gas station, to the gas station parcel delivery management server 104. In exemplary embodiments, when receiving the message notifying that the delivery of the parcel delivery product to the logistics hub has been completed from the gas station parcel delivery management server 104, the parcel delivery company management server 110 may transmit the parcel delivery-related information of the parcel delivery product to a terminal (not illustrated) of a parcel delivery personnel in charge of the logistics hub gas station so as to allow the parcel delivery product to be delivered to the recipient's address from the logistics hub gas station.

According to the disclosed embodiments, by utilizing the unused space of the gas station located in various downtown areas, which allows entry and exit of large lorries and allows loading and unloading of goods, as the logistics hub, it is possible for the customers to conveniently apply for parcel delivery using an application, and it is possible for the parcel delivery companies to increase a logistics collection efficiency in the downtown area while reducing costs, as well as it is possible for the gas stations to create additional profits by utilizing the unused space as a logistics hub for parcel delivery.

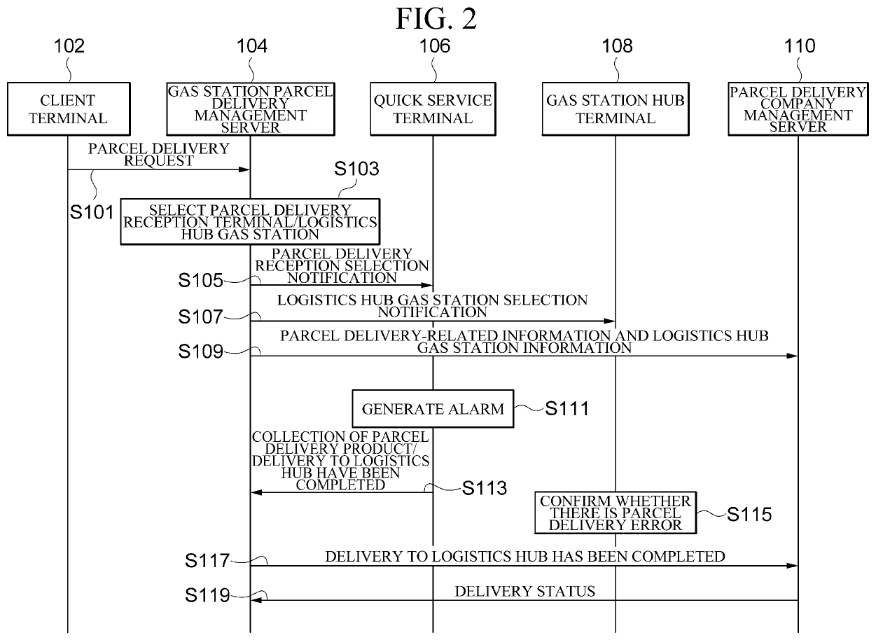

FIG. 2 is a flowchart illustrating a method for a gas station-based parcel delivery service according to one embodiment of the present invention. In the illustrated flow chart, the method is described by dividing it into a plurality of steps, but at least some of the steps may be performed by changing the order, performed together by combining with other steps, omitted, performed by dividing into detailed steps, or performed by adding one or more steps (not illustrated) thereto.

Referring to FIG. 2, the client terminal 102 transmits a parcel delivery request including the parcel delivery-related information to the gas station parcel delivery management server 104 (S101). The parcel delivery-related information may include the parcel delivery sender information, parcel delivery product information, and parcel delivery recipient information.

Next, the gas station parcel delivery management server 104 selects any one terminal among the plurality of quick service terminals 106 communicatively connected to the gas station parcel delivery management server 104 as a parcel delivery reception terminal, and selects a logistics hub gas station to be used as the logistics hub for the parcel delivery product (S103).

Then, the gas station parcel delivery management server 104 transmits a parcel delivery reception selection notification including the parcel delivery-related information and the logistics hub gas station information to the quick service terminal 106 selected as the parcel delivery reception terminal (S105). In addition, the gas station parcel delivery management server 104 transmits a logistics hub gas station selection notification including the parcel delivery-related information and information on the parcel delivery selection terminal to the gas station hub terminal 108 of the logistics hub gas station (S107). Further, the gas station parcel delivery management server 104 transmits the parcel delivery-related information and the logistics hub gas station information to the parcel delivery company management server 110 that covers the logistics hub gas station (S109).

Next, when receiving the parcel delivery reception selection notification from the gas station parcel delivery management server 104, the quick service terminal 106 generates an alarm notifying that it has been selected as the parcel delivery reception terminal (S111). In addition, the quick service terminal 106 may display the sender's address and the address of the logistics hub gas station included in the parcel delivery reception selection notification on the screen thereof.

Thereafter, the quick service terminal 106 sequentially transmits, to the gas station parcel delivery management server 104, a message notifying that the collection of the parcel delivery product has been completed and the delivery thereof to the logistics hub has been completed according to an input of the user (S113).

Next, the gas station hub terminal 108 obtains the parcel delivery-related information recorded on the tag sticker attached to the parcel delivery product, and compares the obtained parcel delivery-related information with the parcel delivery-related information received from the gas station parcel delivery management server 104 to confirm whether there is a parcel delivery error (S115).

Then, when receiving the message notifying that the delivery of the parcel delivery product to the logistics hub has been completed from the quick service terminal 106, the gas station parcel delivery management server 104 transmits, to the parcel delivery company management server 110, a message notifying that the delivery thereof to the logistics hub has been completed (S117).

Thereafter, the parcel delivery company management server 110 transmits the delivery status, in which each parcel delivery product has been delivered to the recipient's address from the logistics hub gas station, to the gas station parcel delivery management server 104 (S119).

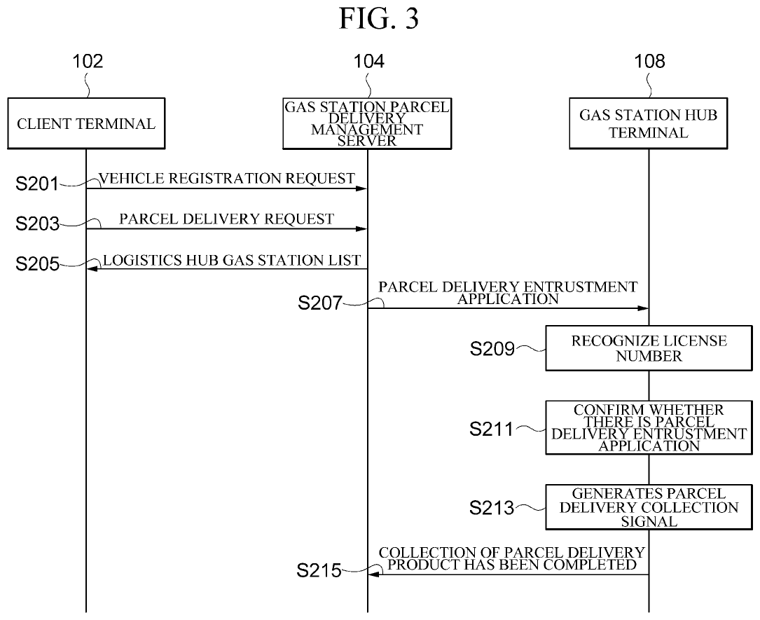

Meanwhile, the parcel delivery sender may directly entrust the parcel delivery product to a gas station registered as the logistics hub gas station, which will be described in detail with reference to FIG. 3. FIG. 3 is a flowchart illustrating a method for a gas station-based parcel delivery service according to another embodiment of the present invention. In the illustrated flow chart, the method is described by dividing it into a plurality of steps, but at least some of the steps may be performed by changing the order, performed together by combining with other steps, omitted, performed by dividing into detailed steps, or performed by adding one or more steps (not illustrated) thereto.

Referring to FIG. 3, the client terminal 102 transmits a vehicle registration request including a license number of the user to the gas station parcel delivery management server 104 (S201). Then, the gas station parcel delivery management server 104 may match and store the license number for each user. Herein, in some cases, the user may be the parcel delivery sender or a parcel delivery recipient.

Next, the client terminal 102 transmits a parcel delivery request including the license number of the user and the parcel delivery-related information to the gas station parcel delivery management server 104 (S203).

Thereafter, when the license number of the user is included in the parcel delivery request, the gas station parcel delivery management server 104 transmits a logistics hub gas station list to the client terminal 102 based on the parcel delivery sender information among the parcel delivery-related information (S205).

That is, when the license number of the user is included in the parcel delivery request, the gas station parcel delivery management server 104 determines that the user directly entrusts the parcel delivery product to the logistics hub gas station, and transmits the logistics hub gas station list to the client terminal 102. For example, the gas station parcel delivery management server 104 may transmit a logistics hub gas station list located within a preset distance based on the address of the parcel delivery sender among the pre-registered logistics hub gas stations to the client terminal 102.

When the client terminal 102 receives the logistics hub gas station list, the user may visit any one of the logistics hub gas stations included in the logistics hub gas station list to entrust the parcel delivery product while refueling when it is necessary for the vehicle to refuel.

Next, the gas station parcel delivery management server 104 transmits a parcel delivery entrustment application including the license number and parcel delivery-related information of the user to the gas station hub terminal 108 of the logistics hub gas stations included in the logistics hub gas station list transmitted to the client terminal 102 (S207).

Then, the gas station hub terminal 108 recognizes a license number of the vehicle entering the gas station (S209). The gas station hub terminal 108 may recognize the license number by analyzing an image captured by a camera (not illustrated) installed at an entrance of the gas station.

Subsequently, the gas station hub terminal 108 confirms whether there is a parcel delivery entrustment application corresponding to the recognized license number (S211). As a result of the confirmation in step S211, when there is the parcel delivery entrustment application corresponding to the recognized license number, the gas station hub terminal 108 generates a parcel delivery collection signal (S213).

In exemplary embodiments, the gas station hub terminal 108 may generate a parcel delivery collection signal including a license number recognized by a gas station employee terminal (not illustrated). In this case, the gas station employee terminal (not illustrated) may be a terminal possessed by an employee of the gas station. When the gas station employee terminal (not illustrated) receives the parcel delivery collection signal, the service station employee approaches the vehicle corresponding to the license number and collects the parcel delivery product from the vehicle user, and then stores the parcel delivery product in the unused space of the service station.

Next, the gas station hub terminal 108 transmits, to the gas station parcel delivery management server 104, a message notifying that the collection of the parcel delivery product for the parcel delivery entrustment application has been completed (S215).

As described above, the parcel delivery sender may entrust the parcel delivery product to the logistics hub gas station while refueling the vehicle. In this case, the quick service process may be omitted, thereby reducing parcel delivery costs.

Meanwhile, the parcel delivery recipient may visit the logistics hub gas station to receive the parcel delivery product. Specifically, the gas station hub terminal 108 may recognize the license number of a vehicle entering the gas station, and confirm whether there is parcel delivery-related information corresponding to the recognized license number. That is, the gas station hub terminal 108 may confirm whether there is the parcel delivery recipient information corresponding to recognized license number among the parcel delivery-related information received from the gas station parcel delivery management server 104.

When there is the parcel delivery-related information corresponding to the recognized license number, the gas station hub terminal 108 generates a parcel delivery signal, so that the service station employee may deliver the parcel delivery product to the user of the vehicle.

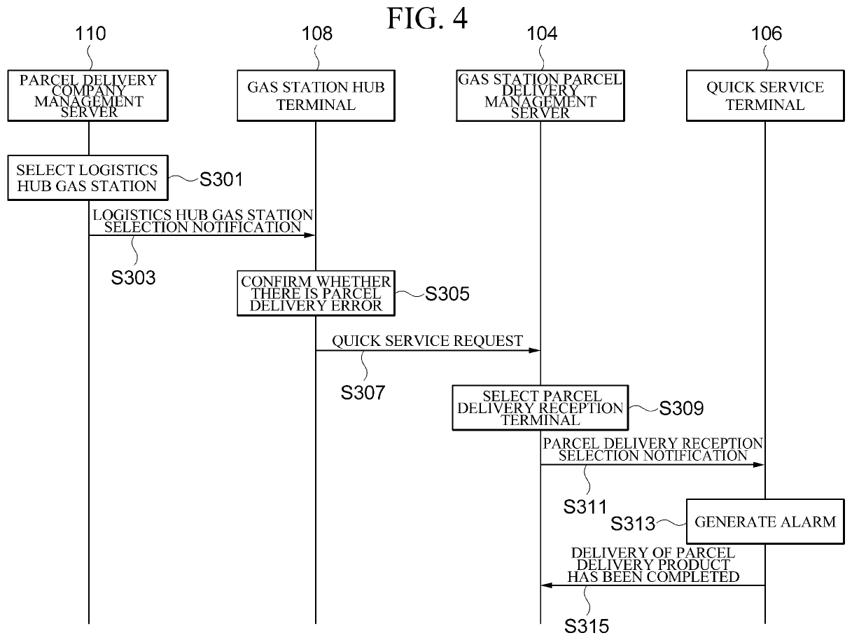

Meanwhile, the parcel delivery company may use the gas station as a parcel delivery logistics hub, and may deliver a product using the quick service from each logistics hub gas station to the parcel delivery recipient, which will be described in detail with reference to FIG. 4.

FIG. 4 is a flowchart illustrating a method for a gas station-based parcel delivery service according to another embodiment of the present invention. In the illustrated flow chart, the method is described by dividing it into a plurality of steps, but at least some of the steps may be performed by changing the order, performed together by combining with other steps, omitted, performed by dividing into detailed steps, or performed by adding one or more steps (not illustrated) thereto.

Referring to FIG. 4, the parcel delivery company management server 110 selects a gas station to be used as the logistics hub for the parcel delivery product based on parcel delivery recipient information among the parcel delivery-related information included in the parcel delivery request (S301). For example, the parcel delivery company management server 110 may select a gas station closest to the address of the parcel delivery recipient among the pre-registered gas stations as the logistics hub for the parcel delivery product.

Then, the parcel delivery company management server 110 transmits a logistics hub gas station selection notification including the parcel delivery-related information to the gas station hub terminal 108 of the gas station selected as the logistics hub gas station (S303). The parcel delivery company may deliver the parcel delivery product to the logistics hub gas station through the parcel delivery personnel. The parcel delivery company management server 110 may transmit the delivery status, in which each parcel delivery product has been delivered to the logistics hub gas station from the parcel delivery company, to the gas station parcel delivery management server 104.

Next, the gas station hub terminal 108 obtains the parcel delivery-related information recorded on the tag sticker attached to the parcel delivery product, and compares the obtained parcel delivery-related information with the parcel delivery-related information received from the parcel delivery company management server 110 to confirm whether there is a parcel delivery error (S305).

As a result of confirming in step S305, if there is no parcel delivery error, the gas station hub terminal 108 transmits a quick service request including the parcel delivery-related information to the gas station parcel delivery management server 104 (S307).

Next, the gas station parcel delivery management server 104 selects any one terminal among the plurality of quick service terminals 106 communicatively connected to the gas station parcel delivery management server 104 as the parcel delivery reception terminal (S309). For example, the gas station parcel delivery management server 104 may select a quick service terminal 106 located closest to the logistics hub gas station as the parcel delivery reception terminal.

Subsequently, the gas station parcel delivery management server 104 transmits a parcel delivery reception selection notification including the parcel delivery-related information and the logistics hub gas station information to the quick service terminal 106 selected as the parcel delivery reception terminal (S311).

Then, when receiving the parcel delivery reception selection notification from the gas station parcel delivery management server 104, the quick service terminal 106 generates an alarm notifying that it has been selected as the parcel delivery reception terminal (S313). In addition, the quick service terminal 106 may display the address of the logistics hub gas station and the address of the parcel delivery recipient included in the parcel delivery reception selection notification on the screen thereof.

Thereafter, the quick service terminal 106 transmits, to the gas station parcel delivery management server 104, a message notifying that the delivery of the parcel delivery product has been completed according to the input of the user (S315). The quick service terminal 106 may transmit the delivery status, in which the parcel delivery product has been delivered to the parcel delivery recipient from the logistics hub gas station, to the gas station parcel delivery management server 104.

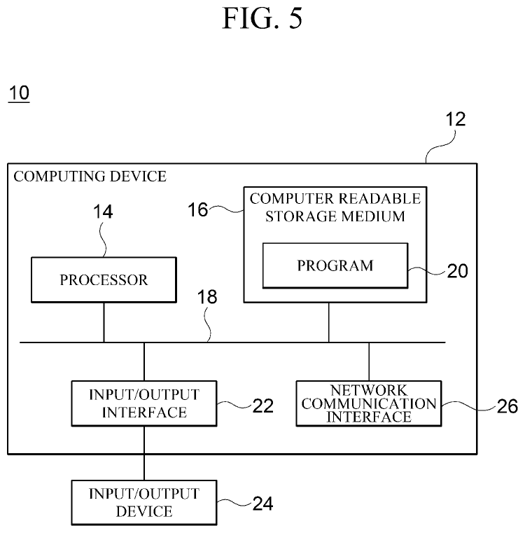

FIG. 5 is a block diagram illustrating and describing a computing environment 10 which includes a computing device suitable to be used in the exemplary embodiments. In the illustrated embodiment, each component may have different functions and capabilities in addition to those described below, and may include additional components in addition to those described below.

The illustrated computing environment 10 includes a computing device 12. In one embodiment, the computing device 12 may be a client terminal (for example, the client terminal 102). In addition, the computing device 12 may be a server computing device (for example, the gas station parcel delivery management server 104) for gas station parcel delivery management. Further, the computing device 12 may be a terminal for a quick service (for example, the quick service terminal 106). Further, the computing device 12 may be a terminal installed in the gas station (for example, the gas station hub terminal 108). Furthermore, the computing device 12 may be a server computing device of the parcel delivery company (for example, the parcel delivery company management server 110).

The computing device 12 includes at least one processor 14, a computer readable storage medium 16 and a communication bus 18. The processor 14 causes the computing device 12 to perform operations according to the exemplary embodiments mentioned above. For example, the processor 14 may execute one or more programs stored in the computer readable storage medium 16. The one or more programs may include one or more computer executable instructions, and the computer executable instructions may be configured to cause the computing device 12 to perform operations according to the exemplary embodiments when executing the program by processor 14.

The computer readable storage medium 16 is configured to store the computer executable instructions or program codes, program data and/or other suitable types of information. A program 20 stored in the computer readable storage medium 16 includes a set of instructions executable by the processor 14. In one embodiment, the computer readable storage medium 16 is a memory (a volatile memory such as a random access memory, a nonvolatile memory, or a suitable combination thereof), one or more magnetic disk storage devices, optical disk storage devices, flash memory devices, other form of storage medium that can be accessed by the computing device 12 and store desired information, or a suitable combination thereof.

The communication bus 18 interconnects various other components of the computing device 12, including the processor 14 and the computer-readable storage medium 16.

The computing device 12 may also include one or more input/output interfaces 22 which provide interfaces for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include input devices such as a pointing device (such as a mouse or trackpad), a keyboard, a touch input device (such as a touchpad or touch screen), a voice or sound input device, various types of sensor devices and/or imaging devices, and output devices such as a display device, a printer, a speaker, and/or a network card. The exemplary input/output device 24 may be included in the computing device 12 as one component forming the computing device 12, or may be connected to the computing device 12 as a separate device distinct from the computing device 12.

Although the representative embodiments of the present invention have been described in detail, it will be understood by persons who have a common knowledge in the technical field to which the present invention pertains that various modifications and variations may be made therein without departing from the scope of the present invention. Accordingly, the scope of the present invention should not be limited to the embodiments, but be defined by the appended claims as well as equivalents thereof.

1. A system for providing a gas station-based parcel delivery service, the system comprising:
a server computing device comprising one or more processors, a memory, and one or more programs, wherein the one or more programs are stored in the memory and configured to be executed by the one or more processors,
wherein the one or more programs comprise instructions that, when executed, cause the server computing device to:
receive a parcel delivery request including parcel delivery-related information from a client terminal;
select a parcel delivery reception terminal and a logistics hub gas station based on the parcel delivery-related information;
transmit a parcel delivery reception selection notification including the parcel delivery-related information and logistics hub gas station information to a quick service terminal selected as the parcel delivery reception terminal;
transmit a logistics hub gas station selection notification including the parcel delivery-related information and information on the quick service terminal to a gas station hub terminal of a gas station selected as the logistics hub gas station; and
transmit the parcel delivery-related information and the logistics hub gas station information to a parcel delivery company management server that covers the logistics hub gas station.

2. The system according to claim 1, wherein the parcel delivery-related information comprises parcel delivery sender information, parcel delivery product information, and parcel delivery recipient information, and
the instruction to select the parcel delivery reception terminal causes the server computing device to select the parcel delivery reception terminal among a plurality of quick service terminals communicatively connected to the server computing device based on a sender's address of the parcel delivery sender information and each location information of the quick service terminals.

3. The system according to claim 1, wherein the parcel delivery-related information comprises parcel delivery sender information, parcel delivery product information, and parcel delivery recipient information, and
the instruction to select the logistics hub gas station causes the server computing device to select the logistics hub gas station based on one or more of the sender's address of the parcel delivery sender information and the location information of the pre-registered gas stations among the pre-registered gas stations.

4. The system according to claim 1, wherein the parcel delivery-related information comprises parcel delivery sender information, parcel delivery product information, and parcel delivery recipient information, and
the one or more programs further comprise instructions that, when executed, cause the server computing device to:
receive, from the quick service terminal, a message notifying that a collection of a parcel delivery product has been completed at the sender's address of the parcel delivery sender information; and
receive, from the quick service terminal, a message notifying that the delivery of the parcel delivery product to the logistics hub gas station as a logistics hub has been completed.

5. The system according to claim 1,
wherein the gas station hub terminal comprises a reader which reads a tag sticker attached to each parcel delivery product, and
the gas station hub terminal is configured to perform operations of:
extracting the parcel delivery-related information from the tag sticker; and
determining whether there is a parcel delivery error according to whether the extracted parcel delivery-related information and the parcel delivery-related information received from the server computing device coincide with each other.

6. The system according to claim 1,
wherein the quick service terminal is configured to perform operations of:
generating an alarm when receiving the parcel delivery reception selection notification from the server computing device; and
displaying a sender's address and an address of the logistics hub gas station included in the parcel delivery reception selection notification on a screen thereof.

7. A system for providing a gas station-based parcel delivery service, the system comprising:
a server computing device comprising one or more processors, a memory, and one or more programs, wherein the one or more programs are stored in the memory and configured to be executed by the one or more processors,
wherein the one or more programs comprise instructions that, when executed, cause the server computing device to:
receive a parcel delivery request including parcel delivery-related information from a client terminal;
confirm whether a license number of a user is included in the parcel delivery request;
generate a logistics hub gas station list based on parcel delivery sender information included in the parcel delivery-related information and transmit the logistics hub gas station list to the client terminal when the license number of the user is included in the parcel delivery request; and
transmit a parcel delivery entrustment application including the license number of the user and the parcel delivery-related information to gas station hub terminals of gas stations included in the logistics hub gas station list.

8. The system according to claim 7, wherein, in the instruction to generate the logistics hub gas station list, the one or more programs extract gas stations located within a preset distance based on a sender's address of the parcel delivery sender information among the pre-registered gas stations to generate the logistics hub gas station list.

9. The system according to claim 7,
wherein the gas station hub terminal is configured to perform operations of:
recognizing a license number of a vehicle entering a gas station where the gas station hub terminal is installed;
confirming whether there is a parcel delivery entrustment application corresponding to the recognized license number; and
when there is the parcel delivery entrustment application corresponding to the recognized license number, generating a parcel delivery collection signal.

10. The system according to claim 9, wherein the gas station hub terminal is configured to further perform an operation of:
after the operation of generating the parcel delivery collection signal,
transmitting, to the server computing device, a message notifying that a collection of a parcel delivery product for the parcel delivery entrustment application has been completed.

11. The system according to claim 7,
wherein the gas station hub terminal is configured to perform operations of:
recognizing a license number of a vehicle entering the gas station where the gas station hub terminal is installed;
confirming whether there is parcel delivery recipient information corresponding to the recognized license number among pre-stored parcel delivery-related information; and
when there is the parcel delivery recipient information corresponding to the recognized license number, generating a parcel delivery signal.

12. A system for providing a gas station-based parcel delivery service, comprising:
a parcel delivery company management server configured to select a logistics hub gas station for a parcel delivery product based on parcel delivery recipient information among parcel delivery-related information included in a parcel delivery request, and transmit a logistics hub gas station selection notification including the parcel delivery-related information;
a gas station hub terminal configured to receive the logistics hub gas station selection notification, obtain the parcel delivery-related information from a tag sticker attached to the parcel delivery product, compare the obtained parcel delivery-related information with the parcel delivery-related information included in the logistics hub gas station selection notification to determine whether there is a parcel delivery error, and transmit a quick service request including the parcel delivery-related information; and
a gas station parcel delivery management server configured to receive the quick service request, select a parcel delivery reception terminal among a plurality of quick service terminals based on a location of the logistics hub gas station and each location of the quick service terminals, and transmit a parcel delivery reception selection notification including the parcel delivery-related information and logistics hub gas station information to the quick service terminal selected as the parcel delivery reception terminal.

13. A method for a gas station-based parcel delivery service performed in a computing device comprising one or more processors, and
a memory which stores one or more programs executed by the one or more processors, the method comprising:
receiving a parcel delivery request including parcel delivery-related information from a client terminal;
selecting a parcel delivery reception terminal and a logistics hub gas station based on the parcel delivery-related information;
transmitting a parcel delivery reception selection notification including the parcel delivery-related information and logistics hub gas station information to a quick service terminal selected as the parcel delivery reception terminal;
transmitting a logistics hub gas station selection notification including the parcel delivery-related information and information on the quick service terminal to a gas station hub terminal of a gas station selected as the logistics hub gas station; and
transmitting the parcel delivery-related information and the logistics hub gas station information to a parcel delivery company management server that covers the logistics hub gas station.

14. The method according to claim 13, wherein the parcel delivery-related information comprises parcel delivery sender information, parcel delivery product information, and parcel delivery recipient information, and
the step of selecting the parcel delivery reception terminal selects the parcel delivery reception terminal among a plurality of quick service terminals based on a sender's address of the parcel delivery sender information and each location information of the quick service terminals.

15. The method according to claim 13, wherein the parcel delivery-related information comprises parcel delivery sender information, parcel delivery product information, and parcel delivery recipient information, and
the step of selecting the logistics hub gas station selects the logistics hub gas station based on one or more of the sender's address of the parcel delivery sender information and the location information of the pre-registered gas stations among the pre-registered gas stations.

16. The method according to claim 13, wherein the parcel delivery-related information comprises parcel delivery sender information, parcel delivery product information, and parcel delivery recipient information, and further comprising:
receiving, from the quick service terminal, a message notifying that a collection of a parcel delivery product has been completed at the sender's address of the parcel delivery sender information; and
receiving, from the quick service terminal, a message notifying that the delivery of the parcel delivery product to the logistics hub gas station as a logistics hub has been completed.

17. A method for a gas station-based parcel delivery service performed in a computing device comprising one or more processors, and
a memory which stores one or more programs executed by the one or more processors, the method comprising:
receiving a parcel delivery request including parcel delivery-related information from a client terminal;
confirming whether a license number of a user is included in the parcel delivery request;
generating a logistics hub gas station list based on parcel delivery sender information included in the parcel delivery-related information and transmitting the logistics hub gas station list to the client terminal when the license number of the user is included in the parcel delivery request; and
transmitting a parcel delivery entrustment application including the license number of the user and the parcel delivery-related information to gas station hub terminals of gas stations included in the logistics hub gas station list.

18. The method according to claim 17, wherein the step of generating the logistics hub gas station list extracts gas stations located within a preset distance based on a sender's address of the parcel delivery sender information among the pre-registered gas stations to generate the logistics hub gas station list.

19. A method for a gas station-based parcel delivery service performed in a computing device comprising one or more processors, and
a memory which stores one or more programs executed by the one or more processors, the method comprising:
receiving a parcel delivery entrustment application including a license number of a user and parcel delivery-related information from a gas station parcel delivery management server;
recognizing a license number of a vehicle entering a gas station where the computing device is installed;
confirming whether there is a parcel delivery entrustment application corresponding to the recognized license number; and
when there is the parcel delivery entrustment application corresponding to the recognized license number, generating a parcel delivery collection signal.

20. The method according to claim 19, further comprising:
after the step of generating the parcel delivery collection signal,
transmitting, to the server computing device, a message notifying that a collection of a parcel delivery product for the parcel delivery entrustment application has been completed.
